(19) United States
(12) Patent Application Publication
(10) Pub. No.: US 2025/0004907 A1
(43) Pub. Date: Jan. 2, 2025

(54) CURATING IT LOGS, BUSINESS LOGS, AND APPLICATION LOGS

(71) Applicant: INTERNATIONAL BUSINESS MACHINES CORPORATION, Armonk, NY (US)

(72) Inventors: Mayank Sharma, BANGALORE (IN); Vinay Nair, Hyderabad (IN); ADITI BHATTACHARYA, Kolkata (IN); SANDEEP DIXIT, Bangalore (IN); Noopur Kumari, Bangalore (IN); Sathyananda K, Bengaluru (IN)

(21) Appl. No.: 18/216,960

(22) Filed: Jun. 30, 2023

(51) Int. Cl. G06F 11/34; H04L 41/16

(52) U.S. Cl. CPC G06F 11/3476; H04L 41/16

(57) ABSTRACT

A system, method, and computer program product are configured to: retrieve business logs and IT logs from a mainframe; extract business events and IT events from the business logs and the IT logs, respectively; relate the business events to the IT events to provide an organized log; retrieve a static application log from the mainframe; correlate the source codes in the static application log with the business event and the IT events in the organized log to provide an event log; and using the event log to automatically anticipate or resolve an error in the mainframe.

### BACKGROUND

Aspects of the present invention relate generally to mainframe management and, more particularly, to methods and systems for curating information technology logs (IT logs), business logs, and static application log so that information from those logs can be mined to manage the mainframe.

Mainframe systems generally operate as closed boxes which handle large workloads in silos. Mainframes typically record events occurring on the system, including IT logs, business logs, and static application log. These logs records events occurring independently on the mainframe and do not relate to each other.

### SUMMARY

In a first aspect of the invention, there is a computer-implemented method including: retrieving, by a processor set, business logs and IT logs from a mainframe; extracting, by the processor set, the business events and IT events from business logs and IT logs, respectively; relating, by the processor set, the business events to the IT events; retrieving, by the processor set, a static application log from the mainframe; correlating, by the processor set, the business events, the IT events, and source codes in the static application log to provide an event log; and using, by the processor set, the event log to automatically anticipate or resolve an error in the mainframe.

In another aspect of the invention, there is a computer program product including one or more computer readable storage media having program instructions collectively stored on the one or more computer readable storage media. The program instructions are executable to: retrieve business logs and IT logs from a mainframe; extract business events and IT events from the business logs and the IT logs, respectively; relate the business events and to the IT events to provide an organized log; retrieve a static application log from the mainframe; correlate the source codes in the static application log with the business event and the IT events in the organized log to provide an event log; and use the event log to automatically anticipate or resolve an error in the mainframe.

In another aspect of the invention, there is a system including a processor set, one or more computer readable storage media, and program instructions collectively stored on the one or more computer readable storage media. The program instructions are executable to: retrieve business logs and IT logs from a mainframe; extract business events and IT events from the business logs and the IT logs, respectively; relate the business events and to the IT events to provide an organized log; retrieve a static application log from the mainframe; correlate the source codes in the static application log with the business event and the IT events in the organized log to provide an event log; and use the event log to automatically anticipate or resolve an error in the mainframe.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows a flowchart of an exemplary method for generating an event log in accordance with aspects of the present invention.

FIG. 4 shows a flowchart of an exemplary method for using the event log in accordance with aspects of the present invention.

### DETAILED DESCRIPTION

Aspects of the present invention relate generally to mainframe management and, more particularly, to methods and systems for curating IT logs, business logs, and static application logs so that information from those logs can be mined to manage the mainframe. According to aspects of the invention, IT logs, business logs, and static application log are retrieved from the mainframe and correlated to provide an event log that can be saved in a knowledge database (KDB). The event log combines previously independent logs of the mainframe and transforms them into a format that can be mined to gain understanding of and to manage the mainframe.

A conventional mainframe records and stores IT logs, business logs, and static application log as independent components, without any automated process to correlate them. There currently exists no procedure to relate IT logs, business logs, and static application log to each other. It is desirable to relate and correlate the IT logs, business events, and static log data to extract insights on the mainframe system and to anticipate and/or to correct system defects, malfunctions, or errors.

Aspects of the present invention provide logic to relate IT logs, business logs, and static application log in an event log, so that the event log can be mined to gain insight into the mainframe system. With current systems, business and IT processes must be developed and modeled by a management team over 3-4 years. By mining the event log developed by aspects of the present invention, business and IT processes can be modeled within hours, a significant saving in time and effort.

Implementations of the invention are necessarily rooted in computer technology. For example, the steps of using the event log to automatically anticipate or resolve an error in the mainframe cannot be performed in the human mind. Training and using a machine learning model are, by definition, performed by a computer and cannot practically be performed in the human mind (or with pen and paper) due to the complexity and massive amounts of calculations involved. For example, an artificial neural network may have millions or even billions of weights that represent connections between nodes in different layers of the model. Values of these weights are adjusted, e.g., via backpropagation or stochastic gradient descent, when training the model and are utilized in calculations when using the trained model to generate an output in real time (or near real time). Given this scale and complexity, it is simply not possible for the human mind, or for a person using pen and paper, to perform the number of calculations involved in training and/or using a machine learning model.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as learning based code at block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

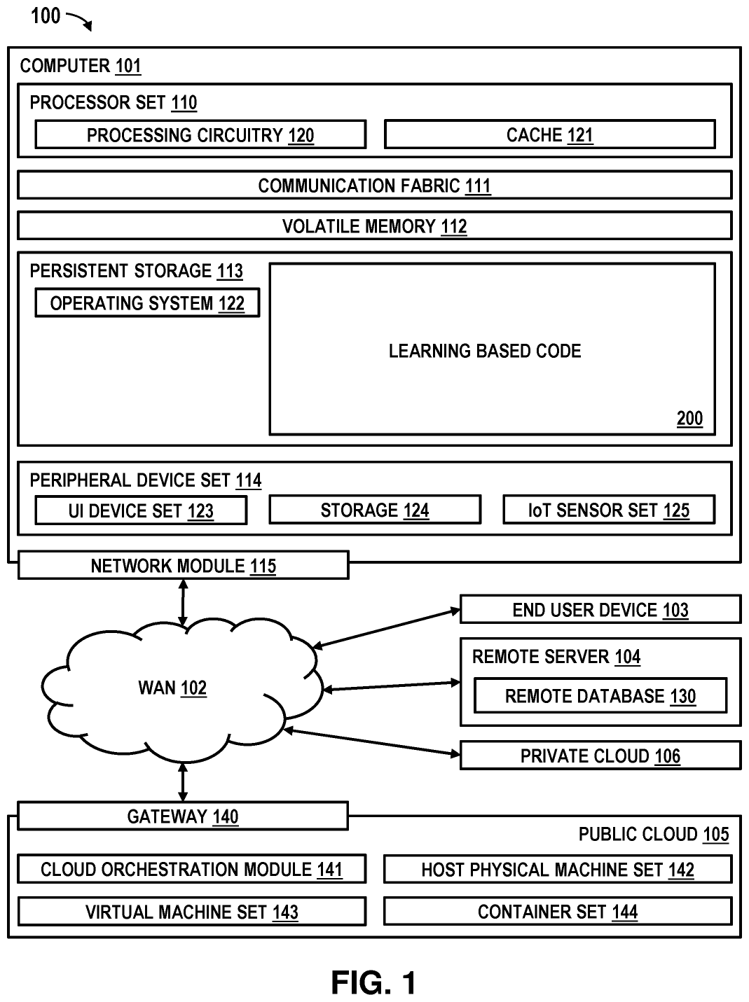

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

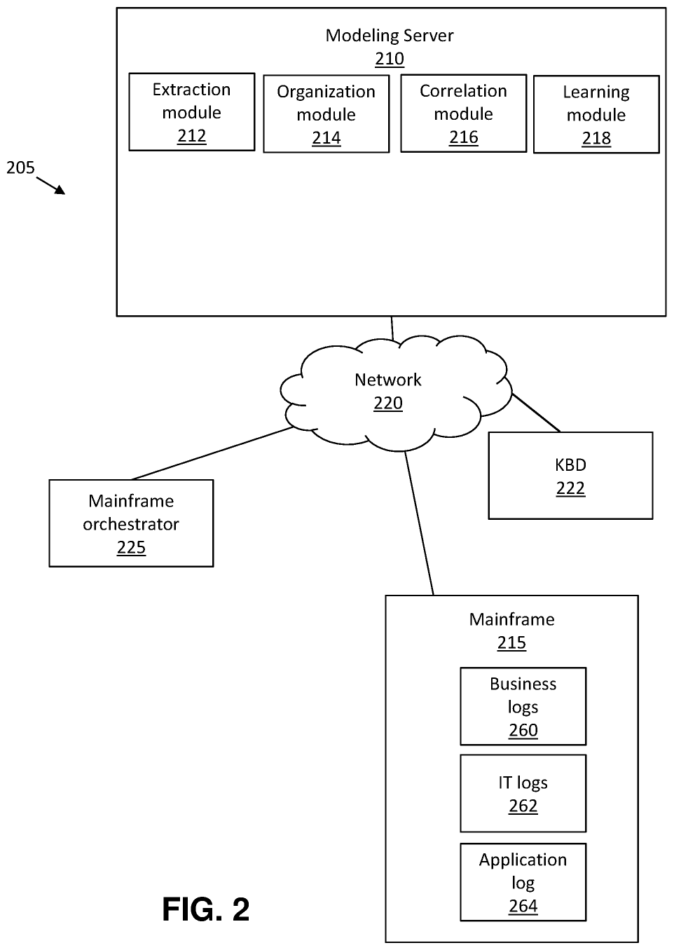

FIG. 2 shows a block diagram of an exemplary environment 205 in accordance with aspects of the invention. In embodiments, the environment 205 includes a modeling server 210, a mainframe 215, and a mainframe orchestrator 225. The modeling server 210, the mainframe 215, and the mainframe orchestrator 225 are in communication over a network 220. In an example, the modeling server 210 comprises one or more instances of the computer 101 of FIG. 1, or one or more virtual machines or one or more containers running on one or more instances of the computer 101 of FIG. 1. The mainframe 215 comprises one or more virtual machines or one or more containers running on one or more instances of the remote server 104 of FIG. 1. The mainframe controller 225 may comprise one or more instances of the EUD 103 of FIG. 1. The network 220 may comprise one or more networks such as the WAN 102 of FIG. 1.

In embodiments, the mainframe 215 includes business logs 260, IT logs 262, and application log 264. The business logs 260 and IT logs 262 are dynamic logs, meaning that they are regularly updated and recorded as events occur on the mainframe 215. The application log 264 is a static log, meaning that it is a one-time log denoting the application(s) that is launched for a particular business event. The application log may be updated as applications are upgraded and modernized, but is not updated automatically by the mainframe 215 as events occur.

The business logs 260 refers to records saved on the mainframe 215 of significant business events (or incidents) within a business environment that have a specific impact on its operations, processes, or outcomes. These business events may be planned or unplanned and may trigger actions or decisions within the organization. Exemplary business events may relate sales, purchase orders, inventory requests, inventory listing, invoice creation, etc. Business events possess a predominantly dynamic essence, emanating from the execution of an application. The business events can range from the straightforward manifestation of diverse process milestones, linked to both the initiation and conclusion markers for the milestones, accompanied by their respective timestamps or activity time. Within certain customer application environments, this may be represented by a mere archival log or audit log stored within a database table throughout the application's runtime. Management of business logs is beneficial for effective decision-making, process optimization, and operational efficiency. Organizations often use business event management systems or workflows to track, monitor, and respond to these logs in a timely manner. By capturing and analyzing business events, organizations can gain insights, identify trends, and make informed strategic decisions.

The information technology logs 262 (also known as IT logs or system logs) are records of events and activities that occur within an information technology (IT) system or infrastructure. These logs provide a detailed account of system events, such as, alerts, errors, warnings, and other relevant information that can help in troubleshooting, monitoring, and auditing of the IT system. There are different types of logs generated within an IT environment, such as, system logs (SYSLOG), job log, operation log (OPERLOG), error log (LOGREC), hard-copy log, security logs, network logs, and database logs. Each type of the IT logs captures specific information related to its corresponding component or system.

The application log 264 refers to a static log that indicates the application source code that is called for a business event. For example, if a purchase order enters the system, the application log indicates that source codes, e.g., 1, 3, and 6, are launched to complete the purchase order. The application log 264 provides instructions for launching particular source code(s) for each particular business event.

In embodiments, the modeling server 210 receives the business logs 260, the IT logs 262, and the application log 264 from the mainframe 215, and combines and curates those logs in a knowledge database (KBD) 222 so that the logs can be used to diagnose and resolve system failures or to anticipate and resolve potential system failures before they occur. The KBD 222 may comprise one or more instances of the remote database 130 of FIG. 1. In embodiments, the modeling server 210 of FIG. 2 comprises an extraction module 212, an organization module 214, a correlation module 216, and a learning module 218, each of which may comprise modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the invention as described herein. These modules of the code of block 200 are executable by the processing circuitry 120 of FIG. 1 to perform the inventive methods as described herein. The modeling server 210 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In accordance with aspects of the invention, the extraction module 212 operates on the business logs 260 and the IT logs 262 to extract information (e.g., business events and IT events) from those logs so that the information can be organized and combined together in the organization module 214. In embodiments, the extraction module 212 uses an open-source framework which provides an interface with the mainframe 215 to enable developers, administrators, and operators to interact with mainframe resources (business logs 260 and IT logs 262) using familiar tools and interfaces. An exemplary of such open-source framework is Zowe®. The extraction module 212, via the open-source framework, retrieves the business logs 260 and the IT logs 262 from the mainframe 215, e.g., as reference tables (leaf tables) format and forwards those tables to the organization module 214.

To extract business events and IT events from the respective logs, the extraction module 212 looks into the code comments of the logs to determine activities occurring in the logs to transform the logs to business events (from business logs 260) and IT events (from IT logs 262). In accordance with aspects of the invention, the extraction module 212 includes automated scripts to look into the code comments of the IT logs 262 and business logs 260 to extract IT events and business events, respectively, therefrom. Business events may be as simple as dumping the display command output information in the application run log or as straightforward as inserting a statement to store a line of text in the audit table, including user and timestamp information. The process of extracting information from these log files involves creating a script using programming languages such as Python, Java, or others, to traverse the extensive collection of log files and identify the message identification (ID) that corresponds to each event. During this process, the script captures the start and end times from the log statements. The extracted text is then consolidated into an output file, providing the business or IT events. Extracting event logs is an independent process that can be generated daily, monthly, or scheduled as per requirements. Another aspect of dynamic logs is the audit logs, which are dumped into database tables. These logs can be extracted by executing an unload job with selected columns. For example, in the IT logs 262, the automated script may look for program names, business units, and functionalities to extract IT events therefrom; in the business logs 260, the automated scripts may look for event names, class names, method names, start time, and stop time to extract business events therefrom.

In accordance with aspects of the invention, the organization module 214 relates or matches the business events (from the business logs 260) and the IT events (from the IT logs 262) based on predefined time window, e.g., within 2 minutes, 5 minutes, 10 minutes, 15 minutes, etc. In embodiments, the predefined time window is adaptable based on different organizational strategies. A lower duration allows for more precise correlations. For example, if an application is triggered by the initiation of an order creation process, which is executed through a Cobol code, an increase in central processing unit (CPU) consumption and memory utilization would be observed during the same timestamp. Due to the large size of logs, organizations can aggregate activities occurring within a 2-5 minute window. However, for more detailed analysis, subject matter experts (SMEs) may decrease the predefined time window. For example, the organization modules 214 provides a table of IT event(s) occurring within 5, 10, and/or 15 minutes of a particular business event. The organization modules 214 identifies business events and IT events occurring within the predefined time window(s) of each business event. In doing so, the organization module 214 combines information from the business logs 260 and the IT logs 262 and correlates the business events and IT events based on time proximity. The organization module 214 provides an organized log of business events and IT events occurring within the predefined time window of each business event, and/or an organized table of IT events and business events occurring within the predefined time window of each IT event.

Although time proximity is discussed herein, other logic may be used to match business events with IT events. The matching of IT events and business events may also be accomplished using pre-defined parameters/rules provided by a subject matter expert (SME) In embodiments, the Business owner (application SMEs) can provide predefined information (reference data) that assists in establishing relationships between various independent logs. This SME provided information serves as the initial reference point to identify these connections. The provided information may include details such as Application-A being installed on both Server-1 and Server-2, with the supported database installed on database (DB) Server-1. Additionally, the provided information may specify that the entire application operates on mainframe hardware VM-1 with an assigned IP address of x.x.x.x. The storage volumes allocated to this application are identified as tag series of STAxx. Similar information may be provided by SMEs for other applications, such as Application B. Application C, and so on. While this information is a one-time activity, it may be revisited in case of any application migration or major infrastructure change or the addition of new components to the system. In addition to time, event location and associated system units involved may be used to match IT events and business events via fuzzy logic. The term “fuzzy logic” is utilized in this context due to the absence of direct correlations between the logs. The objective of the process is to establish correlations based on the reference relation information provided by the SMEs. This involves deriving relationships from diverse logs by taking into account factors such as location, time, and user activity. The initial logic implementation involves extracting keywords from the logs and correlating them with events and static logs. However, to enhance accuracy, a more sophisticated logic can be employed, which includes capturing and analyzing environmental information such as other concurrent applications running on the same machine during the same time period. The discovered matches enable the process to assign weightage to specific correlation activities, with a higher weightage indicating a stronger relationship between the logs. In accordance with aspects of the invention, fuzzy logic may be used to match business events with IT events to produce the organized log. For example, the fuzzy logic utilized in this process is akin to a SQL statement, enabling flexible string matches and comparisons without strict adherence to precise spellings or case sensitivity. In the initial stage (Stage 1), unsanitized data is processed, and generic relations are established. These generic relations serve as a foundation for further refinement in Stage 2, where processing, remediation, updating, and converting the unified case (uppercase) are carried out using the selected data from Stage 1. This iterative process allows for the improvement and enhancement of the generated relations between business events and IT events.

In accordance with aspects of the invention, the correlation module 216 receives data provided by the organization module 214 and the static application log 264 and associates the business events, IT events, and related source codes. In this respect, the correlation module 216 adds related source code(s) (from the application log 264) to each business event and/or IT event in the organized table(s) of the organization module 214. Here, the correlation module 216 provides an event log of business events, IT events occurring within the predefined time window of each business events, and source code(s) activated for each business event; and/or a correlated table of IT events, business events occurring within the predefined time window of each IT events, and source code(s) activated for each IT event. The event log may be presented as a lookup table and saved in the KBD for information mining by the modeling module 218.

In accordance with aspects of the invention, the extraction module 212, the organization module 214, and the correlation module 216 take the business logs 260, IT logs 262, and static application log 264 and determine a correlation of the business events, the IT events, and the source codes. The extraction module 212 extracts business logs 260 and IT logs 262 from the mainframe 215 and transforms the logs into business events and business events. That transformation may be accomplished, e.g., by an automated script to look into the code comments in the business logs and IT logs. The organization module 214 provides the organized table relating the business events and the IT events, e.g., based on time proximity to provide the organized table(s). Fuzzy logic, e.g., may be used to relate or match the business events and IT events. The correlation module 216 extracts the static application log 264 from the mainframe 215 and provides the event log correlating business events, IT events, and source code(s) activated based on time proximity. Because the IT logs 262 and business logs 260 are dynamic, data from those processes should be repeatedly processed through the extraction module 212, organization module 214, and correlation module 216 as those dynamic logs become available. Moreover, as the process is repeated, it is continuously being refined, e.g., by using weight assignment-based algorithm. In embodiments, the weight assignment algorithm works in predefined logic and the weight values are assigned based on the identification of relations through number of matches and misses. A percentage is assigned based on number of matches to calculate the values on the scale of 0 to 100. A higher value indicates a higher level of confidence in the correlation. The value is determined by evaluating the strength of the matches and considering any missed correlations. This allows for a more reliable assessment of the relationships between the IT events and business events.

Although time proximity is discussed herein, other logic to merge the data may be possible as provided by the SME. For example, as noted above, the SME-provided predefined information (reference data) serves as the foundation for establishing relations between the logs. As mentioned above, the information relates to the applications, servers, databases, IP addresses, and other relevant components. This information allows for the creation of correlations and relationships between the business events and IT events to provide valuable context for analysis and interpretation. In accordance with aspects of the invention, the learning module 218 mines the data provided in the event log provided by the correlation module 216 to deliver efficient and timely handling of tickets and incidents (defects, malfunctions, or errors), to quickly prioritize and resolve tickets and incidents, to implement automated solutions, to quickly on-board new team members. The learning module 218 analyzes the event log to automatically discover and visualize the underlying process flows to allow an organization to gain a clear understanding of business processes and their variations. The learning module 218 may apply pattern recognition machine learning to the event log to better understand the relationship between business events and the IT events. For example, pattern recognition may find that certain IT event often occur within five minutes of a certain business event. That finding may be used to identify errors in the source code(s) associated with those events, e.g., by application code analysis. Alternatively, pattern recognition may find that a certain business event (e.g., an incident report) may be resolved by changing certain coding in the associated source code. The learning module 218 may also assist in resolving future incidents by mining the event log for incident reports that have been previously resolved. The learning module 218 may also be used to anticipate defects, malfunctions, or errors so that preemptive measures may be taken before the defects, malfunctions, or errors occurs. For example, the learning module 218 may discover that a certain error occurs frequently for a certain business event on a particular day of the week. In that case, a similar error can be anticipated and resolved before it occurs, so that the system runs smoothly on the particular day of the week.

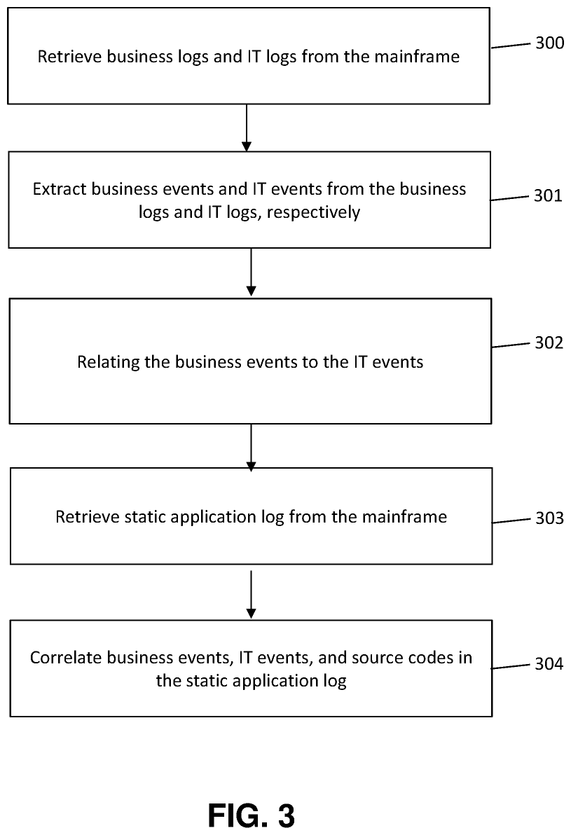

FIG. 3 shows a flowchart of an exemplary method for correlating business events, IT events, and source codes in accordance with aspects of the present invention. Steps of the method may be carried out in the environment of FIG. 2 and are described with reference to elements depicted in FIG. 2.

At step 300, the business logs and the IT logs are retrieved from the mainframe 215. In embodiments, as described with respect to FIG. 2, the extraction module 212 performs this step.

At step 301, the business events and IT events, respectively, are extracted from the business logs 260 and the IT logs 262. In embodiments, and as described with respect to FIG. 2, the extraction module 212 performs this step.

At step 302, the system relates the business events to the IT events. In embodiments, as described with respect to FIG. 2, the organization module 214 performs this step.

At step 303, the system retrieves the static application log 264 from the mainframe 215. In embodiments, as described with respect to FIG. 2, the correlation module 216 performs this step.

At step 304, the system correlates the source codes from the static application log 264 with the business events and the IT events provided in step 302. In embodiments, as described with respect to FIG. 2, the correlation module 216 performs this step.

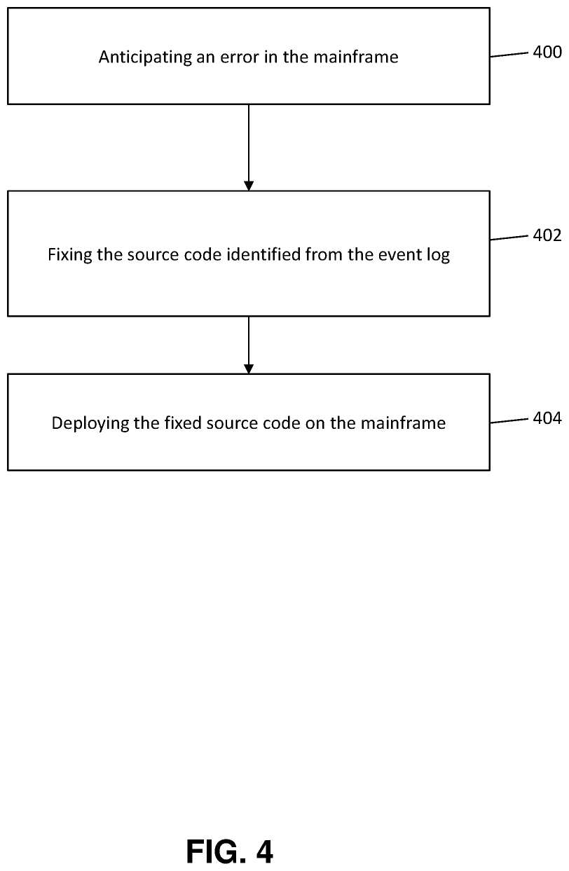

FIG. 4 shows a flowchart of an exemplary use of the modeling server 210 for anticipating and resolving a mainframe error. As noted previously, the learning module 218 of the modeling server 210 may be used to anticipate error, e.g., for a business event. In box 400, the modeling server 210 predicts an error by mining the event log. In box 402, the error is fixed by first using the event log produced by the correlation module 216 to determine the source code(s) involved in the error. Those source code(s) are then analyzed and fixed, e.g., by the orchestrator 225. Once fixed, in box 404, the fixed source code(s) are deployed on the mainframe.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer 101 of FIG. 1, can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising the steps of:
retrieving, by a processor set, business logs and information technology logs (IT logs) from a mainframe;
extracting, by the processor set, business events and IT events from the business logs and the IT logs, respectively;
relating, by the processor set, the business events to the IT events to provide an organized log;
retrieving, by the processor set, a static application log from the mainframe;
correlating, by the processor set, the source codes in the static application log with the business event and the IT events in the organized log to provide an event log; and
using, by the processor set, the event log to automatically anticipate or resolve an error in the mainframe.

2. The computer-implemented method of claim 1, wherein the business events comprise one or more selected from the group consisting of sales, purchase orders, inventory requests, inventory listing, and invoice creation.

3. The computer-implemented method of claim 1, wherein the IT logs comprise system logs (SYSLOG), job log, operation log (OPERLOG), error log (LOGREC), hard-copy log, application logs, security logs, network logs, and database logs.

4. The computer-implemented method of claim 1, wherein the IT events comprise one or more selected from the group consisting of system events, errors, and warnings.

5. The computer-implemented method of claim 1, wherein the relating comprises relating the business events to the IT events based on time proximity.

6. The computer-implemented method of claim 5, wherein the relating comprises relating the business events to the IT events based on occurring within a predefined time period of each other.

7. The computer-implemented method of claim 1, wherein the event log is presented as lookup table.

8. The computer-implemented method of claim 1, further comprising mining the event log.

9. The computer-implemented method of claim 8, wherein the mining comprises saving the event log in a knowledge base database (KDB).

10. The computer-implemented method of claim 9, wherein the mining comprises using pattern recognition machine learning to anticipate errors or to resolve errors.

11. A computer program product comprising one or more computer readable storage media having program instructions collectively stored on the one or more computer readable storage media, the program instructions executable to:
retrieve business logs and IT logs from a mainframe;
extract business events and IT events from the business logs and the IT logs, respectively;
relate the business events to the IT events to provide an organized log;
retrieve a static application log from the mainframe;
correlate the source codes in the static application log with the business event and the IT events in the organized log to provide an event log; and
use the event log to automatically anticipate or resolve an error in the mainframe.

12. The computer program of claim 11, wherein the relating comprises relating business events to IT events based on time proximity.

13. The computer program of claim 11, wherein the relating comprises relating the business events to the IT events based on occurring within a predefined period of each other.

14. The computer program of claim 11, wherein the event log is presented as lookup table.

15. The computer program of claim 11, wherein the program instructions are executable to mine the event log.

16. The computer program of claim 15, wherein the mining comprises saving the event log in a knowledge base database (KDB).

17. The computer program of claim 15, wherein the mining comprises using pattern recognition machine learning to anticipate errors or to provide solution for errors.

18. A system comprising a processor set, one or more computer readable storage media, and program instructions collectively stored on the one or more computer readable storage media, the program instructions executable to:
retrieve business logs and information technology logs (IT logs) from a mainframe;
extract business events and IT events from the business logs and the IT logs, respectively;
relate the business events to the IT events to provide an organized log;
retrieve a static application log from the mainframe;
correlate the source codes in the static application log with the business event and the IT events in the organized log to provide an event log; and
use the event log to automatically anticipate or resolve an error in the mainframe.

19. The system of claim 18, wherein the relating comprises relating business events to IT events based on time proximity.

20. The system of claim 18, wherein the program instructions are executable to mine the event log to anticipate errors or to provide solution for errors.
